(19) United States
(12) Patent Application Publication
(10) Pub. No.: US 2004/0136408 A1
(43) Pub. Date: Jul. 15, 2004

(54) Digital data transmitting apparatus, digital data receiving apparatus, and digital data communication apparatus

(75) Inventors: Osamu Tomobe, Hitachi (JP); Takaharu Ishida, Hitachinaka (JP)

Correspondence Address: CROWELL & MORING LLP, INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 10/447,145

(22) Filed: May 29, 2003

(30) Foreign Application Priority Data
Jan. 15, 2003 (JP) 2003-6504

(51) Int. Cl. H04J 3/04

(52) U.S. Cl. 370/532

(57) ABSTRACT

In order to effectively use a band and securely transmit emergency information such as information of disasters because such information needs to be securely provided to a user most preferentially via a digital broadcasting receiver held by the user even when the user is outside, digital data is multiplexed on the basis of transmission volume of the digital data, and data type, priority and data effective time as attributes of the digital data, and the multiplexed digital data is transmitted.

### BACKGROUND OF THE INVENTION

1. Field of the Invention

This invention relates to an apparatus for multiplexing and transmitting digital data such as digitized video signals, audio/acoustic signals, traffic information, weather information, or tourist information, an apparatus for receiving such data, or a series of such systems.

2. Description of the Related Art

Recently, as digital broadcasting using communication satellites, broadcasting satellites and ground waves, and distribution of video and audio streams using the Internet and portable telephones are examined for various applications, there is a large demand for effective use of limited transmission bands. As can be seen from the broadcasting band for mobile units per broadcasting station, which is several hundred kbps to several Mbps, the resource of information transmission line is limited. A system for effectively transmitting plural program contents to users of mobile units through this limited transmission band is necessary.

To effectively use the transmission band that is not fully used, a method of equalizing data for stream transmission and thus realizing a constant bit rate in transmission (first method) and a method of using a gap between data for stream transmission and a transmission band to transmit another data (second method) are considered.

In the case of the first method, when various contents are to be provided, the average bit rate of streams tends to increase when realizing a constant bit rate of streams. Therefore, though the bit rate value within the band on the broadcasting station side can be guaranteed, unnecessary bits might be transmitted. When the bit rate of streams is lowered, if stuffing bytes are used to realize a constant bit rate, the reproducing time on the receiver side is delayed by the amount of the stuffing bytes. When the bit rate of streams is temporarily increased, the bits at the part where the bit rate is increased are delayed and allocated to parts where the bit rate is equal to or less than the average bit rate, thereby realizing a constant bit rate. Therefore, a transmission delay occurs and the reproducing time on the receiver side is delayed accordingly.

On the other hand, as the second method, the method described in JP-A-2001-111969 is known. This method is to send data to a free transmission band while allowing the bit rate of streams. This method enables effective use of the transmission band but it requires complicated processing and the processing efficiency must be improved in order to distribute multiplexed streams in real time.

Actual digital information has a transmission bit size that often changes in terms of time series, that is, per unit time. FIG. 5 shows the state of use of a band in the second method. FIG. 5 shows that a band to be used of a video/audio band 210 changes in accordance with the time. The difference between a cut-transmittable area and the video/audio band 210 represents an unused band 200.

In stream transmission, it is well known that the band to be used of video and audio data, which required to have a real-time property, varies depending on the coding system. In the case of video data of MPEG-2 Video or MPEG-4 Video, the bit rate tends to be lowered where the video before compression has less motion, and the bit rate tends to be lowered where the video before compression has more active motion. These data are required to have a real-time property and therefore must be controlled by several milliseconds.

Therefore, with the transmission system as in the conventional digital communication and broadcasting, in which the transmission band capacity is decided on the basis of the maximum bit rate of video and audio data, the transmission rate is low in actual stream transmission and the transmission band often cannot be effectively used.

Patent Literature 1:

JP-A-2001-111969

### SUMMARY OF THE INVENTION

In view of the foregoing status of the art, it is an object of the present invention to effectively use a band.

It is another object of the present invention to securely transmit emergency information such as information of a disaster, since such information needs to be given the highest priority and securely provided to a user via a digital broadcasting receiver held by the user even when the user is outside. It is still another object of the present invention to enable appropriate provision of information to the user without interrupting a program enjoyed by the user or lowering the quality of program information.

The objects of the present invention are achieved by multiplexing digital data on the basis of transmission volume of the digital data, and data type, priority and data effective time as attributes of the digital data, and transmitting the multiplexed digital data.

According to the present invention, a band can be effective used.

Moreover, emergency information can be securely transmitted. In such a case, it is possible to provide information without interrupting a program enjoyed by the user or lowering the quality of program information.

### BRIEF DESCRIPTION OF THE DRAWINGS

FIG. 1 shows a digital distribution system.

FIG. 2 is a functional block diagram showing a transmitting apparatus.

FIG. 3 shows a hardware structure of a transmitting apparatus and a receiving apparatus.

FIG. 4 shows a protocol stack.

FIG. 5 shows the state of use of a band (with a free area).

FIG. 6 shows a priority setting screen.

FIG. 7 shows a priority setting table.

FIG. 8 is a structural view showing a multiplexing slot.

FIG. 9 is flowchart showing the processing of a multiplexing scheduler.

FIG. 10 shows the state of use of a band (where emergency information, traffic information and POI are distributed using a free area).

FIG. 11 is a functional block diagram showing a receiving apparatus.

FIG. 12 is a flowchart showing the processing by the receiving apparatus.

FIGS. 13A to 13C show a screen flow on the receiving apparatus.

FIGS. 14A to 14C show a screen flow on the receiving apparatus.

### DESCRIPTION OF THE PREFERRED EMBODIMENTS

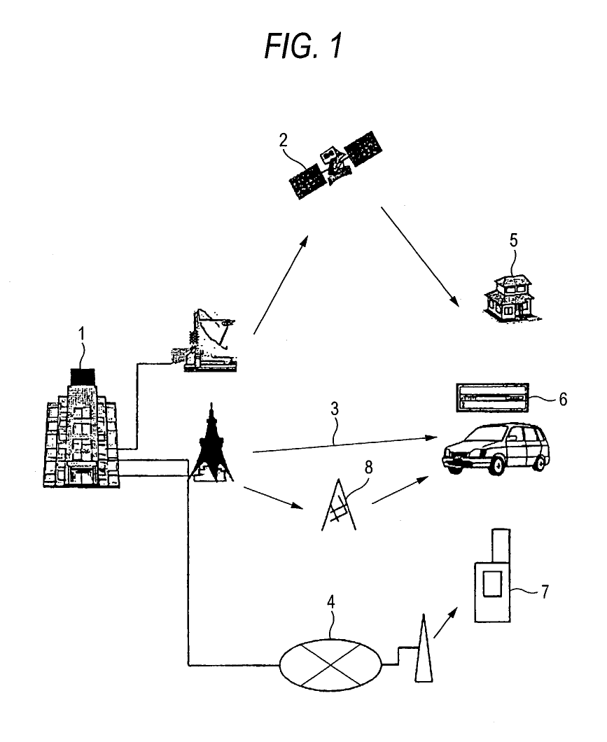

First, a system for providing digital data will be described as a whole with reference to FIG. 1.

An information center 1 is an enterprise that collectively performs gathering, management and distribution of ITS information, weather information, traffic information, tourist information and the like. The information center 1 provides information to a stationary receiver 5, a mobile receiver 6 provided on an automobile or the like, or a portable terminal 7 such as PDA or portable telephone through transmission using a transponder of a satellite 2, transmission based on a digital modulation system such as orthogonal frequency division multiplexing OFDM of ground waves 3, or transmission via the Internet 4. A gap filler 8 is a device installed in a region where the electric field strength of broadcast waves of terrestrial digital broadcasting is not sensed. The gap filler 8 functions as a repeater.

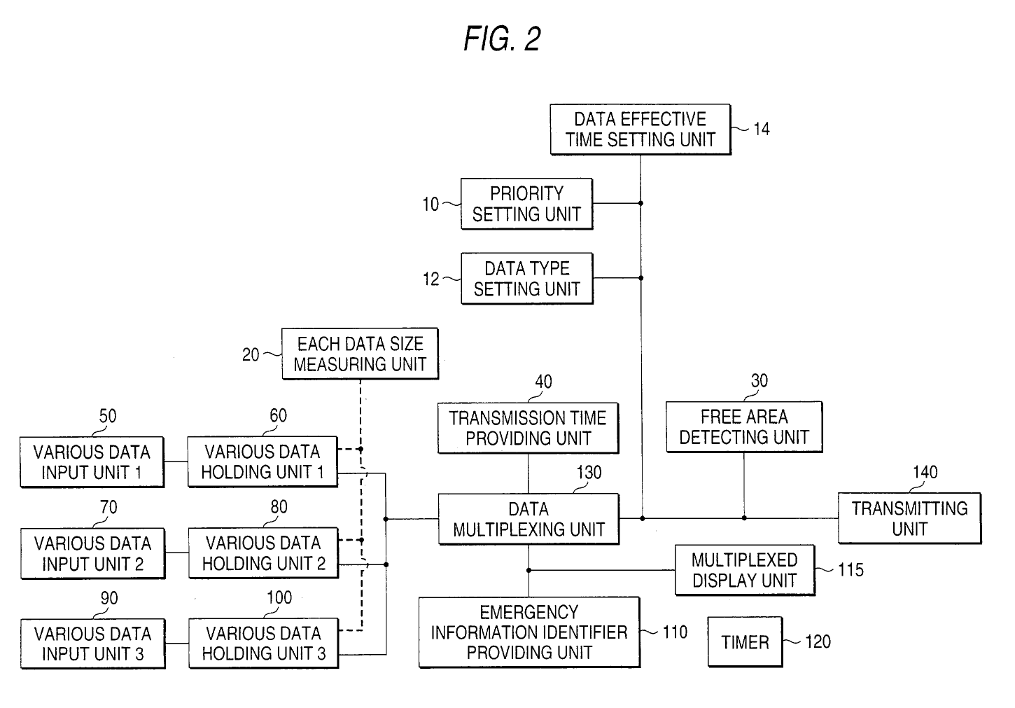

The station facilities in the information center 1 will now be described with reference to FIG. 2.

A various data input unit 1 (50) is a unit for inputting bit stream data outputted from a device that compresses data using a video coding system prescribed by ISO/IEC 14496-2 such as MPEG-4 Video.

A various data input unit 2 (70) is a unit for inputting bit stream data outputted from a device that compresses data using an CD-like audio coding system prescribed by ISO/IEC 13818-7 such as MPEG-2 AAC.

A various data input unit 3 (90) is a unit for inputting traffic information data, point-of-interest information POI, and emergency information data such as information of a disaster.

Distribution of traffic information data in Japan is performed by an information provision system based on the Vehicle Information and Communication System (VICS). A similar traffic information provider exists in Europe.

For the provision of traffic information in Japan, at present, there are a system based on FM broadcast, a system based on radio beacon, and a system based on optical beacon. Traffic information is classified three levels, that is, level 1, which is a display system using characters, level 2, which is a system for displaying road traffic information using simplified graphics, and level 3, which is a system for superimposing road traffic information on a map screen of an on-vehicle machine such as a car navigation device. The coding system for transmission of such traffic information is prescribed and the traffic information is expressed in a binary form.

Point-of-interest information POI is information related to points of interest such as restaurants and parking lots. For example, in the case of a restaurant, the following group of information is includes:

1. Name “OX restaurant”;

2. Longitude and Latitude “135°E and 38°N”;

3. Contact “0294-XX-XXXX”;

4. Comment “Hamburger at a special price now!”; and

5. etc.

The content of emergency information includes what has occurred, for example, earthquake, thunder, fire, or tidal wave. Also the date, time and place of the emergency information are described.

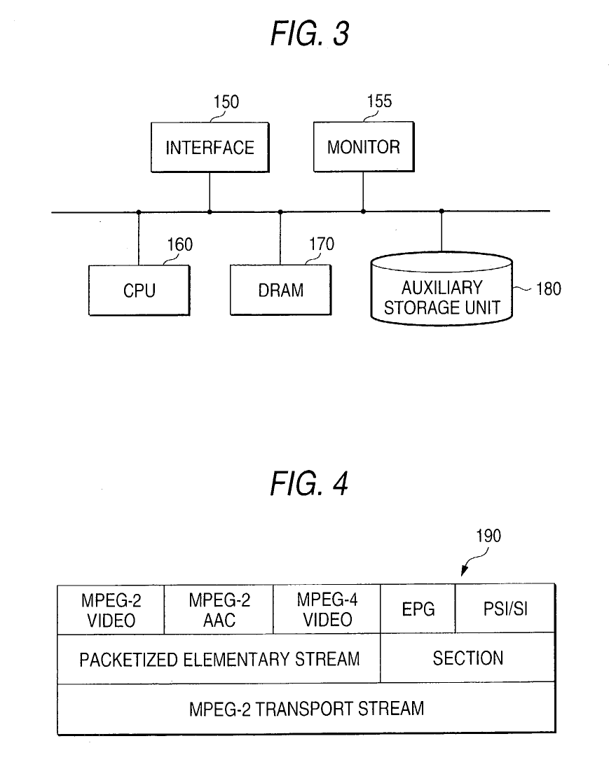

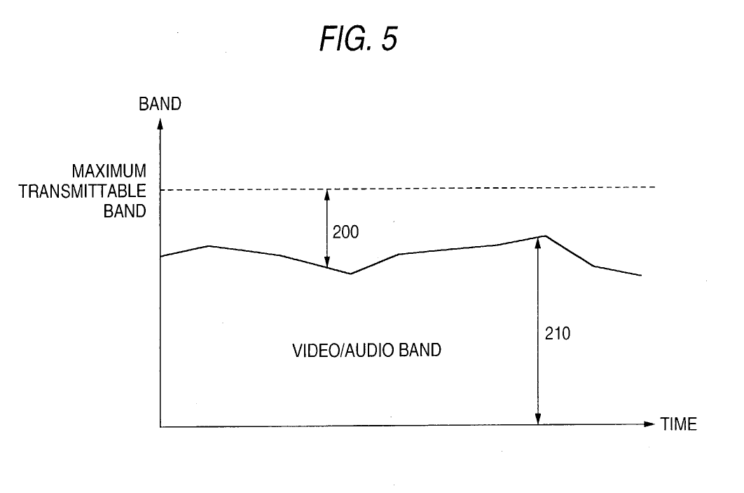

Data inputted from the various data input unit 1 (50) is buffered to a various data holding unit 1 (60). Data inputted from the various data input unit 2 (70) is buffered to a various data holding unit 2 (80). Data inputted from the various data input unit 3 (90) is buffered to a various data holding unit 3 (100). The buffering can also be realized by a main memory such as DRAM (see FIG. 3).

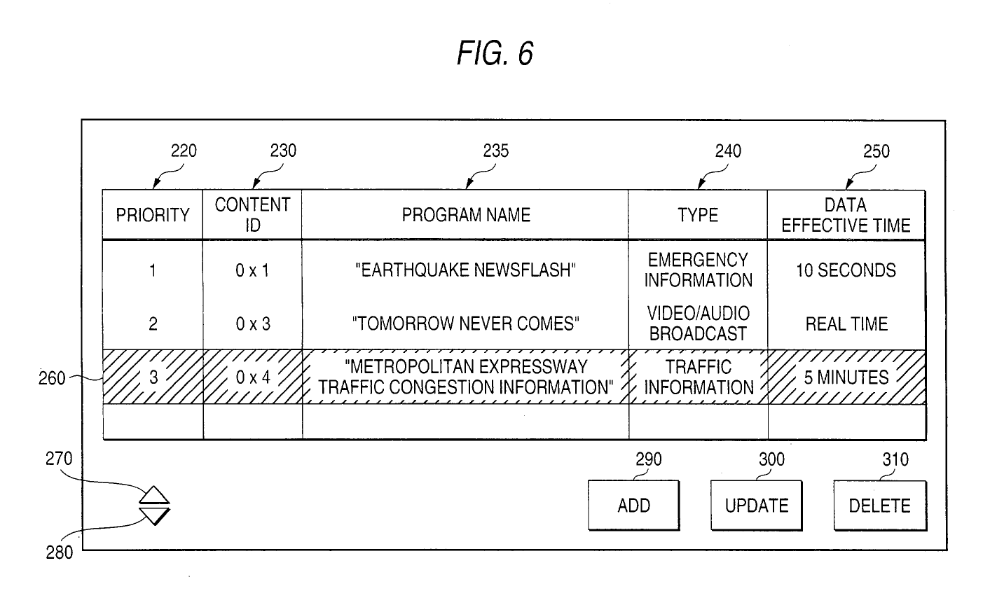

A priority setting unit 10 is a unit for inputting what schedule is used for multiplexing the data inputted by the various data input units 1, 2 and 3. A user sets this priority setting unit 10 through a human-machine interface such as a graphical user interface. A data type setting unit 12 is a unit for setting the category of each program. A data effective time setting unit 14 sets a maximum time during which data of a program should be transmitted to a terminal. The priority setting unit 10, the data type setting unit 12 and the data effective time setting unit 14 are stored in a DRAM 170 or an auxiliary storage unit 18 of FIG. 3, which will be described later. These units will be described in detail with reference to FIG. 6.

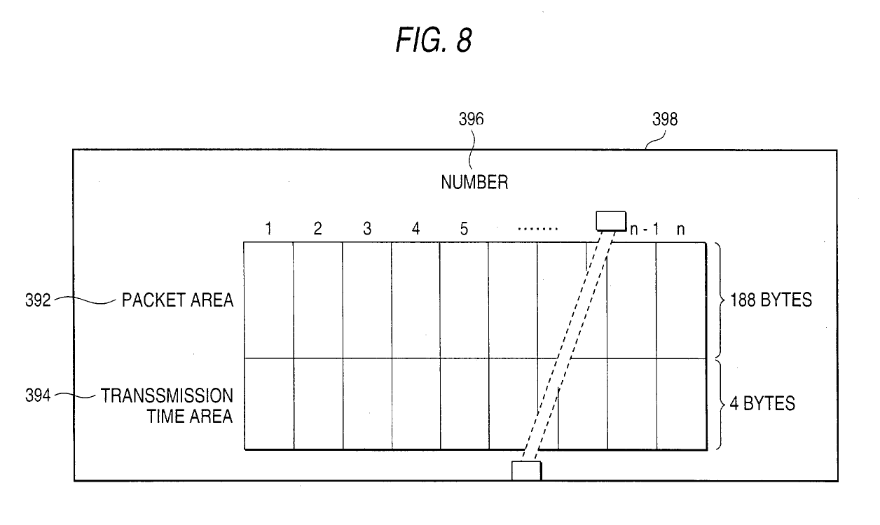

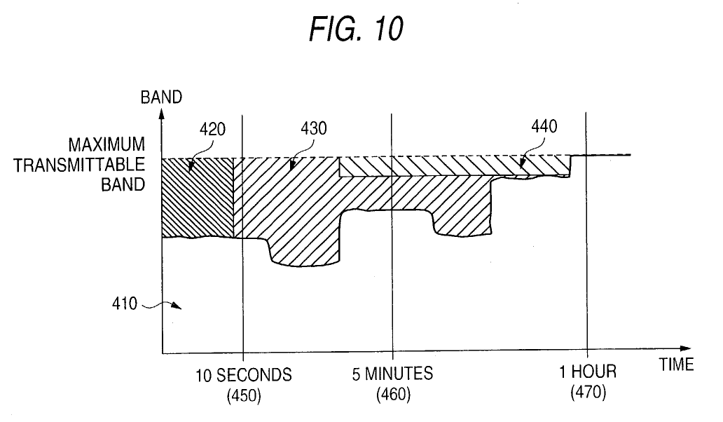

Each data size measuring unit 20 periodically measures the size of the data stored in the various data holding units 1, 2 and 3, using a timer 120. In order to multiplex data by a data multiplexing unit 130, a slot 398 for multiplexing as shown in FIG. 8 is secured in a main memory. From multiplexed data, a graph as shown in FIG. 10 is generated by a multiplexed display unit 115 and displayed on a monitor 155.

A free area detecting unit 30 detects a free area in the slot 398 on the main memory. The detected free area is selected as a write area when multiplexing the data.

A transmission time providing unit 40 is used for providing a transmission time of each data and thus managing each data. To acquire a transmission time to be provided, the data size is measured and the transmission time is calculated on the basis of a data effective time 250 indicating the time by which the data should be sent.

An emergency information identifier providing unit 110 provides an emergency information identifier when emergency information is inputted by the various data input unit 3. In digital broadcasting, the emergency information identifier can be described in a program information table (PSI/SI) such as NIT (network information table) or PAT (program map table). This is described in detail in ISO/IEC 13818-1 System.

A transmitting unit 140 is a unit for digitally modulating and then transmitting the data multiplexed in the slot 398. As an exemplary digital modulation system, the OFDM system in digital broadcasting may be used. Similar to the current analog television broadcasting, transmission at 6 MHz per bandwidth of one RF channel is possible. In a system (ISDB-T system) prescribed by the Ministry of Posts and Telecommunications as a “provisional system for terrestrial digital television broadcasting” in September 1998, an OFDM signal in a 6-MHz band is divided into 13 segments so that each broadcasting station can freely use segments to distribute a program. For example, it is possible to provide a service in which 10 segments of the 13 segments are for fixed receivers at homes or the like, 2 segments for mobile units such as map display units provided on car navigation devices and PDAs, or portable terminals, and the remaining 1 segment for audio radio broadcasting. Moreover, the OFDM modulation system can be changed every segment.

Such transmission is referred to as hierarchical transmission. This hierarchical transmission enables change by segment with transmission parameters classified into three hierarchical levels at the maximum in accordance with service requirements, for example, increasing the transmission band of data for home, or employing a robust system as in a mobile receiver. In the case of satellite communication and broadcasting, a TDM modulation system or a CDM modulation system can be used.

FIG. 3 shows an exemplary hardware structure necessary for realizing the function of FIG. 2. An I/F 150 for inputting data is a medium such as Ethernet (communication circuit), DVB-ASI, DVB-SPI, RS-422, floppy disk (storage medium), CD-ROM, or CD-RAM. A monitor 155 is a graphics display device such as a liquid crystal display or CRT. A CPU 160 is a device for driving the function of FIG. 2. A DRAM 170 is a memory area for realizing the various data holding units 1, 2, 3 (60, 80, 100) or the slot 398 (see FIG. 8). The auxiliary storage unit 180 is hardware such as a hard disk, DVD-RAM, or compact flash (PC card).

FIG. 4 shows a protocol stack 190 as an example for transmitting data. MPEG-2 Video, MPEG-2 AAC, and MPEG-4 Video format each access unit of data into a packetized elementary stream. EPG, which is an electronic program guide, and PSI/SI, which means program schedule information, format data in a section format. The formatted data is then formatted into an MPEG-2 transport stream format prescribed by ISO/IEC 13818-1:2000.

FIG. 6 shows a human-machine interface for setting the priority for distribution of plural digital data to be distributed. When setting the priority, values are entered to items of priority 220, content ID 230, type 240, and data effective time 250. When deciding addition, the user presses an add button 290. As the add button 290 is pressed, information is registered with respect to each item. When an up button 270 is pressed, a shaded part, which indicates that selection is made, moves and a list is selected. To decide update of items in the selected list, the user presses an update button 300. To delete an added list, the user presses the up button 270 or a down button 280 to move the shaded part in the list, thereby selects a list to be deleted, and then presses a delete button 310 to decide deletion.

Information related to the priority will now be described. The priority 220 designates the priority of transmission data. In accordance with this priority, the content ID 230 is ID for internally and univocally identifying data to be inputted. The type 240 is a name indicating the content of data to be inputted. The data effective time 250 is an item indicating the time by which inputted data should be transmitted. If the value is “real time”, data is distributed simultaneously with its input. If a time period such as “5 minutes” or “1 hour” is designated, data is scheduled to be sent within that time period.

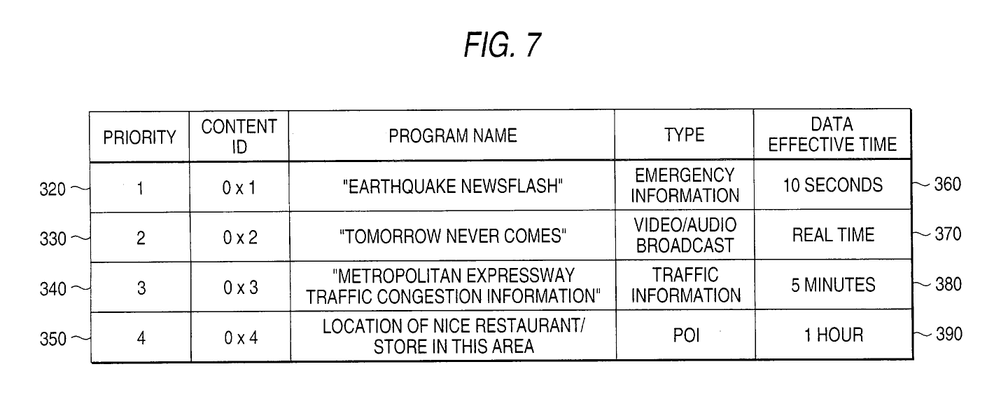

A table shown in FIG. 7 is an exemplary stable generated by the priority setting screen shown in FIG. 6 and is stored inside the transmitting apparatus. The content of this table can be added, updated, or deleted at any time.

FIG. 8 shows a structure of the slot 398 for multiplexing data. The slot 398 includes sets of packet area 392 and transmission time area 394. There are n sets of packet area 392 and transmission time area 394, and numbers 1 to n, denoted by a reference numeral 396, are allocated to the sets. The value of n is changed in accordance with the requirements of the system. The value of n can be updated by a value substituting unit in a program. In this embodiment, the size of the packet area is 188 bytes and the size of the transmission time area is 4 bytes.

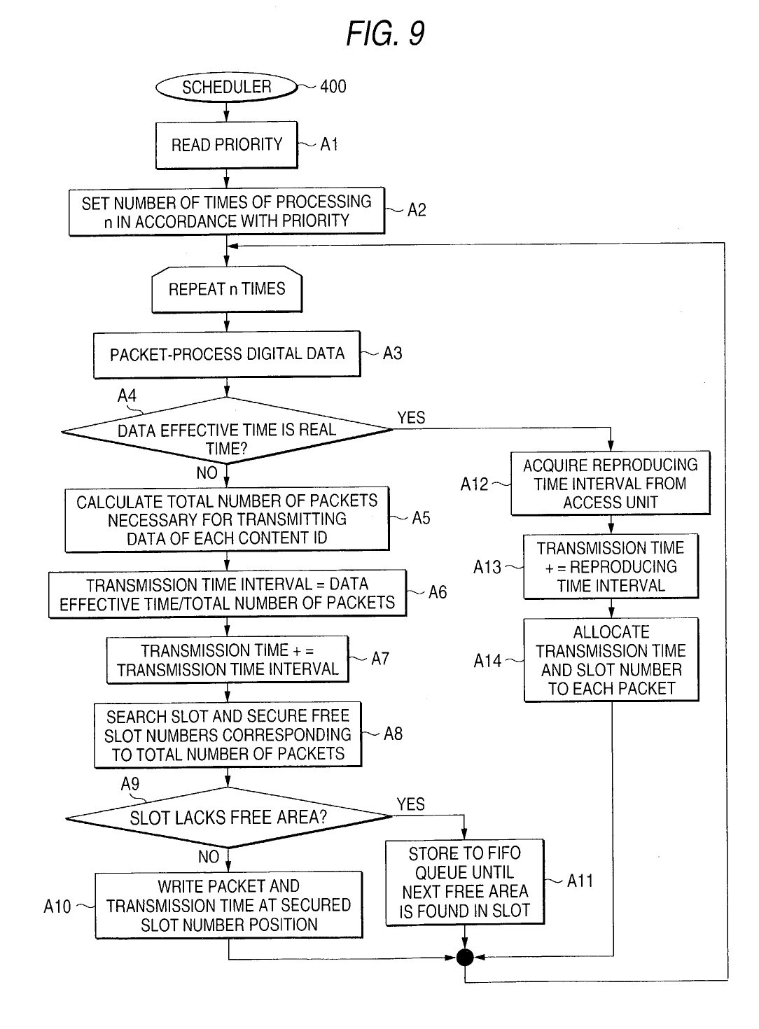

FIG. 9 shows a processing flow of a scheduler 400 for multiplexing. First, the scheduler 400 reads the priority using the CPU 160 (A1) and accesses the number of times of processing n from a correspondence table showing the correspondence between the priority value held by the scheduler in advance and the number of times of processing n, thereby setting the number of times of processing n (A2). In the correspondence table showing the correspondence between the priority value and the number of times of processing n, for example, the number of times of processing can be decided as follows: when the priority value is 1, the number of times of processing n is 4, of the total number of times of processing, which is 10; when the priority value is 2, the number of times of processing n is 3; when the priority value is 3, the number of times of processing n is 2; and when the priority value is 4, the number of times of processing n is 1. With respect to the relation between the priority and the number of times of processing, the number of times of processing corresponding to the priority value may be changed depending on applications of broadcasting. After that, digital data packet processing is performed (A3). If the data effective time is real time (A4), the reproducing time interval is acquired from an access unit (A12). Then, to calculate the transmission time, arithmetic operation of “transmission time+=reproducing time interval” is executed at the CPU 160 (A13). After that, the transmission time and the slot number are allocated to each packet (A14).

On the other hand, if the data effective time is not real time (A4), the processing shifts to processing A5. In the processing A5, the total number of packets necessary for transmitting data of each content ID is calculated on the basis of the payload size of the packet. In this embodiment, the payload size of the packet is fixed to 184 bytes. However, it is simplified for explanation and the operation can be performed also in the case of a variable payload size. Practically, the payload size varies depending on applications.

Next, to calculate the transmission time interval, arithmetic operation of “transmission time interval=data effective time÷total number of packets” is executed at the CPU 160 (A6). Moreover, to calculate the transmission time, arithmetic operation of “transmission time+=transmission time interval” is executed at the CPU 160 (A7).

Next, the slot 398 is searched for a number 396 where no data exists in the packet area, and numbers 396 corresponding to the total number of packets are secured (A8). If no free area is found in the slot at this point (A9), the data is stored into a FIFO queue until the next free area is found in the slot (A11). If there is a free area in the slot 398 (A9), the packetized digital data and the transmission time are written at the position of the secured slot number (A10).

In the case of distributing data in accordance with the priority of information provision to the user and the effective time of information itself, or when the priority is low but the effective time is short, the priority is evaluated first, and then the transmission time of a packet to be transmitted is calculated for the effective time of each data. In this embodiment, the scheduler 400 weights the frequency of access by the CPU 160 for each priority rank, thereby deciding the frequency of repetition of the processing A3 to A14.

As the priority when distributing data in a free area is set in this manner, arrival and reception of emergency information will not be delayed.

When the priority is high but the effective time is long, or when the priority is low but the effective time is short, a task is allocated to various data for each priority rank using the function of the scheduler and the transmission time of each packet is calculated from the effective time of each data. Therefore, the data can be transmitted with high accuracy and within the effective time.

FIG. 10 schematically shows the use of a band by each digital data under the control of the scheduler. A video/audio broadcast 410 is data to be transmitted in real time and therefore its multiplexing is decided by access unit. An access unit in MPEG-2 Video or MPEG-4 Video is a unit obtained by, for example, compressing one video frame. On the other hand, in the case of audio data of MPEG-2 AAC or the like, a decodable minimum unit is prescribed by ISO/IEC 13818-7. As a result, data to be transmitted in real time can be distributed within a predetermined time even if it is interrupted by other data. Meanwhile, emergency information has the top priority but may be sent in 10 seconds (450). Therefore, emergency information is allocated to the slot 398 most preferentially. Traffic information 430 has a data effective time of 5 minutes (460) and POI 440 has a data effective time of 1 hour (470). Since the traffic information and POI can be sent in a sufficiently narrow band, these can be transmitted simply by using a free area of a band without disturbing the band of the main broadcast such as video/audio broadcast.

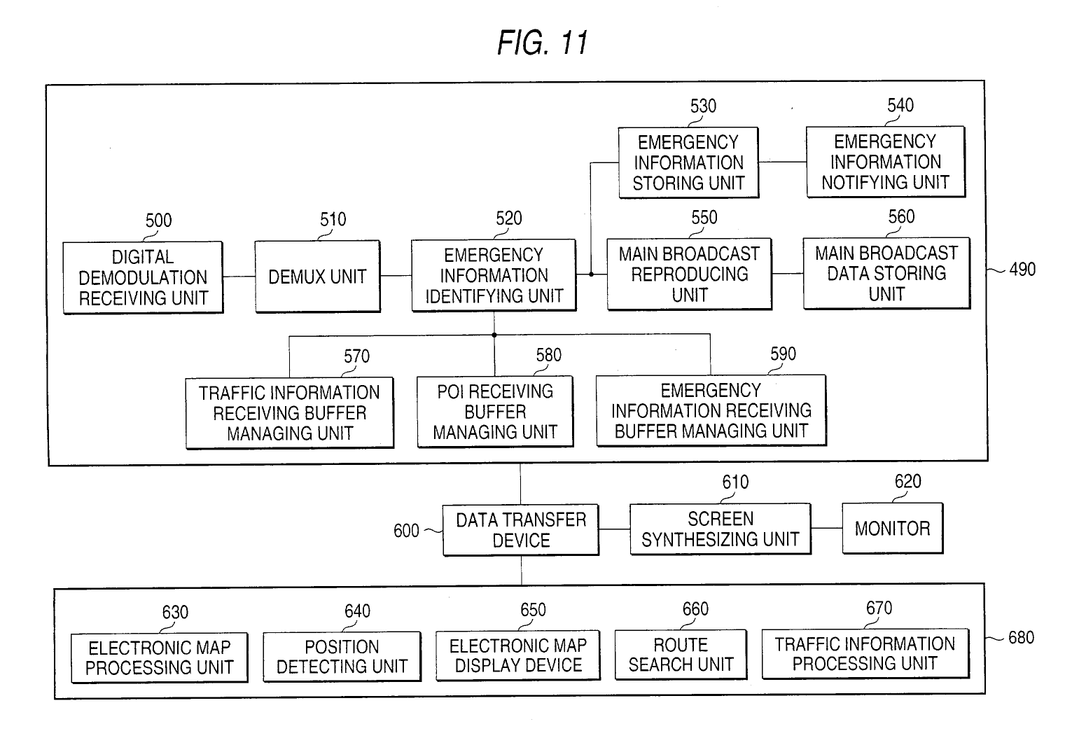

A receiving apparatus will now be described. FIG. 11 shows the receiving apparatus.

Unlike video signals and audio/acoustic signals, which are required to have a real-time property, digital data such as point-of-interest information, traffic information, weather information, tourist information and commercial information are needed by the user at different timing. For example, in some cases, point-of-interest information needs to be taken out after digital broadcast is received. For traffic information and weather information, digital information is generated intermittently and therefore the user does not demand a real-time property by millisecond or the like of these data. However, a time limit indicating the time by which the data should reach the user is required. That is, the effective time of the data exists. Emergency information such as information of disasters, for example, heavy rain, typhoon, earthquake, lightning strike, fire, tidal wave and terrorism, is necessary only in a limited number of occasions a year but must be securely sent and transmitted to the user as in real time as possible.

In short, the receiver side needs to secure an appropriate buffer size while considering the memory resource. On the other hand, some users do not want emergency information to interrupt a program that is received up to that time. Therefore, it is necessary to prevent deterioration in quality of program information that the user is currently watching.

The receiving apparatus (FIG. 11) includes a front-end processing device 490 for performing modulation/demodulation and data processing of digital communications and broadcasting, a data transfer device 600, and a navigation device 680 like a device recently provided on an automobile as an on-vehicle machine.

The front-end processing device 490 includes a digital demodulation receiving unit 500 for demodulating OFDM, TDM and CDM-modulated signals, a DEMUX unit 510 for filtering necessary digital data from the digital data acquired by demodulation processing, an emergency information identifying unit 520 for identifying an emergency information identifier indicating that the acquired information is emergency information, an emergency information storing unit 530 for securing the acquired emergency information in a DRAM or auxiliary storage unit of the receiving apparatus, an emergency information notifying unit 540 for notifying the user of the secured emergency information via a monitor, a main broadcast reproducing unit 550 for reproducing the video/audio broadcast 450, a main broadcast data storing unit 560 for backing up the main broadcast when acquiring emergency information and notifying the user of the emergency information, a traffic information receiving buffer managing unit 570, a POI receiving buffer managing unit 580, and an emergency information receiving buffer managing unit 590.

The navigation device 680 includes an electronic map processing unit 630 for processing an electronic map stored in a CD-ROM, DVD-ROM or compact flash (PC card) or an electronic map acquired through digital communication or digital broadcasting, and performing image processing such as scaling and scroll, a position detecting unit 640 for detecting the position of a measuring point using a latitude/longitude measuring device such as GPS or PHS, an electronic map display unit 650 for displaying the electronic map processed by the electronic map processing unit 630, a route search unit 660 for searching for a route from the measuring point to a destination, and a traffic information processing unit 670 for mapping the acquired traffic information data on the electronic map or converting the traffic information to graphic information.

The data transfer device 600 is used for transferring data from the front-end processing device 490 to the navigation device 680, and at the same time, transferring the data from the front-end processing device 490 and display data from the navigation device 680 to a screen synthesizing unit 610 to display the data on a monitor 620. A minimum unit of hardware for realizing the receiving apparatus is shown in FIG. 3. In addition, a monitor device such as a liquid crystal display and a data transmission bus are necessary.

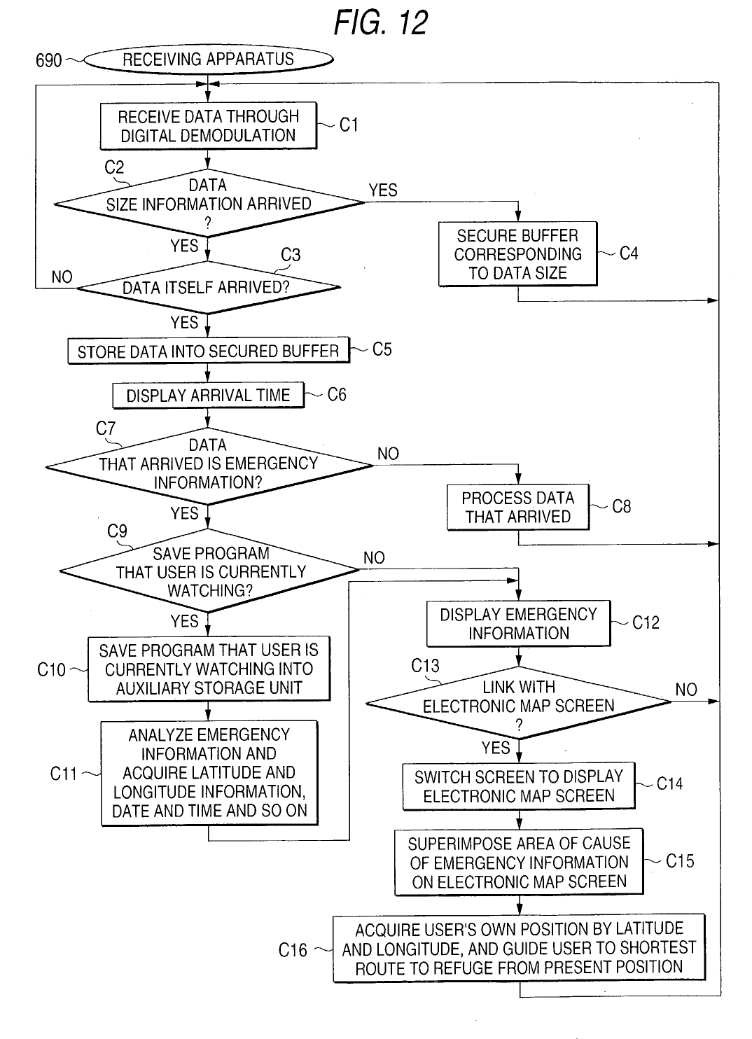

A processing flow of a receiving apparatus 690 will now be described with reference to FIG. 12.

The receiving apparatus receives data through digital demodulation (C1). As data size information arrives, a buffer corresponding to the data size is secured (C4). As data itself arrives (C3), the data is stored into the secured buffer (C5) After that, the arrival time is displayed (C6). If the data that arrived is emergency information (C7), whether a program that the user is currently watching should be saved or not is confirmed (C9). If the program that the user is current watching should be saved, the program is saved into an auxiliary storage unit such as DVD-RAM or HDD (C10). Next, the emergency information is analyzed and the content of the emergency information, latitude/longitude information, date and time and the like are acquired (C11). If the program that the user is currently watching should not be saved, the emergency information is displayed on the monitor 620 by the emergency information notifying unit 540 after the processing C11. If the emergency information is to be linked with an electronic map screen (C13), the electronic map screen is displayed by the screen synthesizing unit 610 (C14) and an area where the cause of the emergency information exists is superimposed on the electronic map screen (C15). Then, the position of the user is acquired by the position detecting unit 640 and the user is guided to the shortest route to a refuge from the user's present position (C16). If the data that arrived is not emergency information (C7), the data that arrived is processed by the front-end processing device 490 or the navigation device 680 (C8).

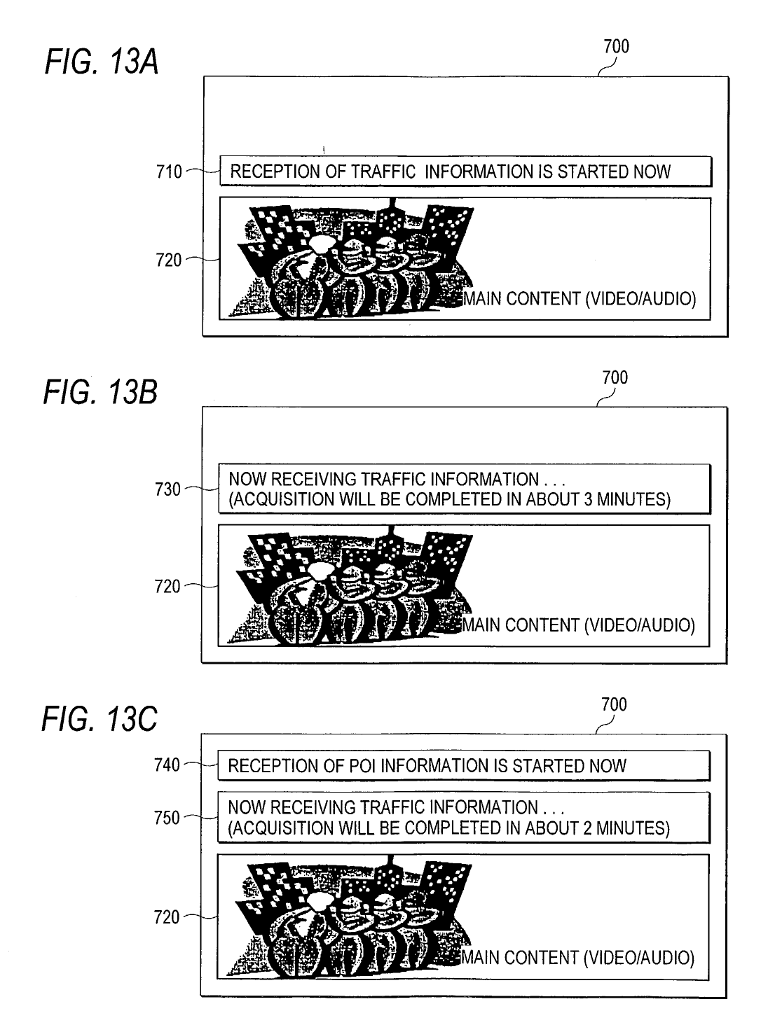

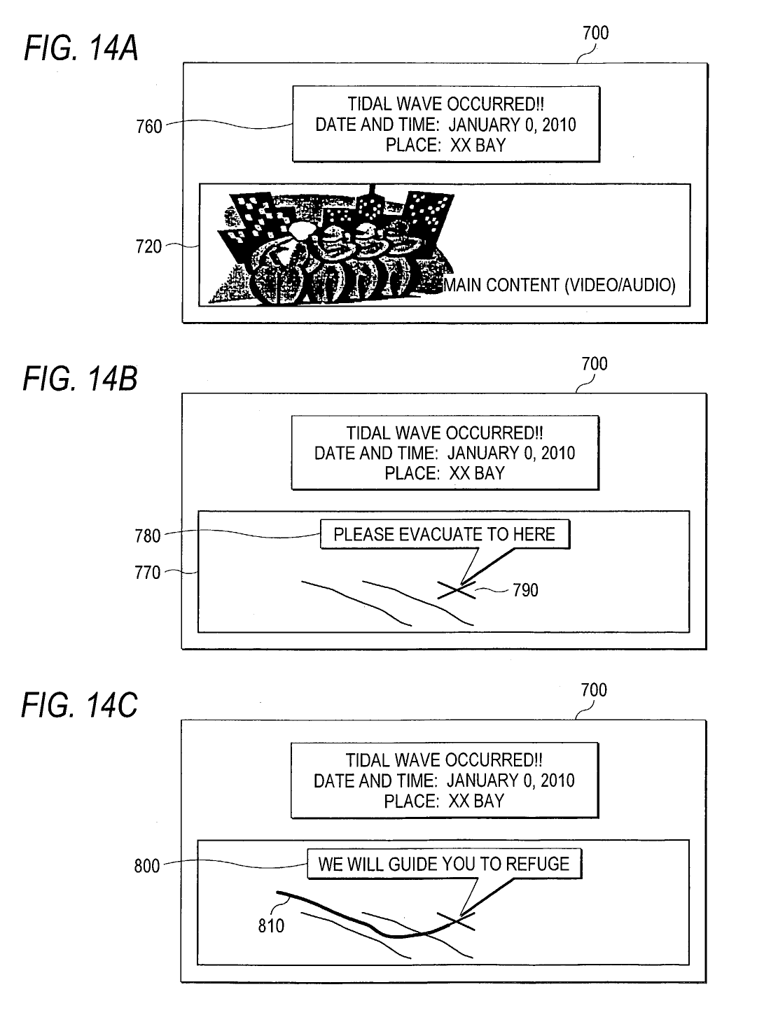

FIGS. 13A to 13C and FIGS. 14A to 14C show screen flows on the receiving apparatus.

FIGS. 13A to 13C show the receiving status of acquired data. In FIG. 13A, a main content (main broadcast screen) 720 of video/audio is sequentially acquired in real time, processed by the receiving apparatus, and displayed on a monitor screen 700. At the same time, it is shown that acquisition of traffic information is started. A dialog “Reception of traffic information is started now” 710 is displayed.

FIG. 13B shows that acquisition of traffic information will be completed in 3 minutes. A dialog “Now receiving traffic information. (acquisition will be completed in about 3 minutes)” 730 is displayed.

FIG. 13C shows that acquisition of POI is started and that acquisition of traffic information will be completed in 2 minutes. A dialog “Reception of POI information is started now” 740 and a dialog “Now receiving traffic information. (acquisition will be completed in about 2 minutes” 750 are displayed.

In FIG. 14A, emergency information is acquired and its detailed information 760 is displayed on the monitor screen 700. In this case, the main content (video/audio) 720 is unchanged.

In FIG. 14B, the main content 720 of video/audio is temporarily stored in the auxiliary storage unit and a map screen 770 is displayed. A refuge position 790 near the user's position is found and the user is notified of this refuge position by a dialog “Please evacuate to here” 780.

In FIG. 14C, route guide from the user's position to the refuge position 790 is processed by the navigation device 680 and a guide route 810 is superimposed on the map.

In this manner, since this system automatically displays a position to which the user should evacuate and route guide to the position to which the user should evacuate on the navigation device built in or connected with the receiving apparatus, using quickly acquired emergency information, it can be a system to protect safety of people.

As described above, since various digital information can be efficiently multiplexed and efficiently transmitted, the transmission band can be effectively used. As a result, the rate of use with respect to the band use fee can be improved. In the case of transmission in a narrow band as in communications and broadcasting for mobile units, the transmission band can be used more efficiently and emergency information can be acquired quickly at a position outside such as the destination of travel or business trip.

Moreover, the transmission apparatus can be constructed by a relatively inexpensive system as shown in FIG. 3. Therefore, the maintenance of the apparatus is easy and the cost of the apparatus can be reduced. Packaging and implementation of the functions of the transmission apparatus can be realized using a commercially available CPU and the processing description can be realized by software.

What is claimed is:

1. A digital data transmitting apparatus having a data type setting unit, a priority setting unit, and a data effective time setting unit, the digital data transmitting apparatus comprising:
a data size measuring unit for measuring a transmission volume of the digital data;
a data multiplexing unit for multiplexing the digital data on the basis of the transmission volume, and data type, priority, and data effective time, which are attributes of the digital data set by the setting units, and
a transmitting unit for transmitting the multiplexed data.

2. The digital data transmitting apparatus as claimed in claim 1, further comprising:
a transmission time providing unit for setting a transmission time on the basis of the data effective time; and
a packet generating unit for packetizing the digital data when transmitting the digital data;
wherein the transmission time providing unit provides a time to the packet.

3. The digital data transmitting apparatus as claimed in claim 2, wherein the packet generating unit has plural hierarchical levels for generating a packet and generates a packet after adding a header to each hierarchical level, and
the transmission time providing unit provides a transmission time to a packet of a header added to the lowermost hierarchical level for packet generation.

4. The digital data transmitting apparatus as claimed in claim 1, further comprising an emergency information identifier providing unit for providing an emergency information identifier to digital data to be transmitted when the digital data is emergency information.

5. The digital data transmitting apparatus as claimed in claim 4, wherein the digital data which is emergency information includes information of the content of the emergency information, date and time of occurrence of the emergency information, and the place of the emergency information.

6. The digital data transmitting apparatus as claimed in claim 1, further comprising a multiplexed display unit for displaying the multiplexed content.

7. A digital data receiving apparatus for receiving digital data multiplexed on the basis of a data transmission volume of a digital data transmitting apparatus, and the data type of the digital data, the priority of the digital data, and the effective time of the digital data, the digital data receiving apparatus comprising:
a received data storing unit for storing the received digital data;
a received data storing buffer size deciding unit for deciding a size of a received data storing buffer;
a demultiplexing unit for demultiplexing the multiplexed data; and
a demultiplexed data storing unit for storing the demultiplexed data.

8. The digital data receiving apparatus as claimed in claim 7, wherein when the digital data is emergency information, the digital data has an emergency information identifier,
the digital data receiving apparatus further comprising:
an emergency information identifying unit for identifying the emergency information identifier;
an emergency information storing unit for storing the emergency information;
an emergency information display unit for displaying the emergency information;
a main broadcast display control unit for deciding whether to keep or stop display of a main broadcast when displaying the emergency information;
a main broadcast storing unit for storing the main broadcast when receiving the emergency information; and
a main broadcast reproducing unit for reproducing the stored main broadcast.

9. The digital data receiving apparatus as claimed in claim 8, further comprising:
a electronic map display unit for displaying an electronic map;
a latitude/longitude acquiring unit for acquiring latitude/longitude information of the receiving apparatus;
an emergency position information analyzing unit for analyzing position information inserted in the emergency information; and
a refuge acquiring unit for acquiring a refuge.

10. The digital data receiving apparatus as claimed in claim 9, wherein the refuge acquiring unit comprises:
a refuge storing unit for storing a list of refuges; and
a refuge guide unit for guiding to an optimum refuge using refuge information acquired from the refuge storing unit, information acquired by the latitude/longitude acquiring unit of the receiving apparatus, and emergency position information in the emergency information.

11. A digital data communication apparatus for transmitting and receiving digital data multiplexed on the basis of a data transmission volume of a digital data transmitting apparatus, and the data type of the digital data, the priority of the digital data, and the effective time of the digital data, the digital data communication apparatus comprising:
a data type setting function; a priority setting function; a data effective time setting function; a data size measuring function for measuring the transmission volume of the digital data; a data multiplexing function for multiplexing the digital data on the basis of the transmission volume, and the data type, priority, and data effective time, which are attributes of the digital data set by the setting functions; and a transmitting function for transmitting the multiplexed data; and
a received data storing function for storing received digital data; a received data storing buffer size deciding function for deciding a size of a received data storing buffer; a demultiplexing function for demultiplexing multiplexed data; and a demultiplexed data storing function for storing the demultiplexed data.
